(19) United States
(12) Patent Application Publication
(10) Pub. No.: US 2020/0077607 A1
(43) Pub. Date: Mar. 12, 2020

(54) ARTICLE FOR ENRICHING SOIL FERTILITY

(71) Applicant: PS Global Sdn Bhd, Subang Jaya (MY)

(72) Inventors: Kim Fui NG, Shah Alam (MY); Lee Yien THANG, Kuantan (MY)

(21) Appl. No.: 16/444,037

(22) Filed: Jun. 18, 2019

(30) Foreign Application Priority Data
Sep. 6, 2018 (SG) 10201807686Q

(51) Int. Cl. A01G 29/00; C05G 3/00; C05F 11/08

(52) U.S. Cl. CPC A01G 29/00; C05G 3/0041; C05F 11/08; C05G 3/0029; C05G 3/0082

(57) ABSTRACT

The present disclosure relates to an article for enriching soil fertility, a method of manufacturing the same and a method of enriching soil fertility. The article comprising a container comprising a fluid-permeable membrane, a fertilizer disposed in the container and a moisture regulator disposed in the container. The moisture regulator is configured to repeatedly absorb moisture from outside the container and release the absorbed moisture into a space within the container based on a moisture gradient existing between the space within the container and outside the container, to control a release of the fertilizer from the container through the membrane. The moisture regulator is further configured to form a base in the space within the container to harbor moisture-sensitive microbes, the microbes being transferable through the membrane based on the moisture gradient.

### FIELD OF INVENTION

The present invention relates broadly, but not exclusively, to an article for enriching soil fertility, a method of manufacturing the same and a method of enriching soil fertility.

### BACKGROUND

Nutrients and water deficiencies can impede the growth of plants. Rapid urbanisation and excessive use of land cause land degradation problems to become increasingly severe. Issues such as high levels of heavy metals and salinity in the soil can affect the conditions of the soil that is used for crop cultivation. Elevated threat of land degradation may compromise the agricultural yield and sustainability.

Agricultural land needs to be constantly manured and treated to avoid these problems. For example, a piece of land can be manured by providing suitable amounts of water and fertilizers to the soil. This may mitigate the effects of different types of abiotic and biotic stresses, thus enhancing the growth of crops. Farmers can manually provide manure to the crops. Other applications such as irrigation systems can be employed in the process.

However, the manuring and treatment processes may be cumbersome if the land area is relatively large. Also, the processes may be expensive yet ineffective due to various reasons. For example, water supply may be interrupted by climate variations such as an occurrence of drought. This deprives the crops of nutrients and thus, stressing the crops at critical growth stages.

A need therefore exists to provide an article for enriching soil fertility and a method of manufacturing the same that seek to address at least one of the problems above or to provide a useful alternative.

### SUMMARY

According to a first aspect of the present invention, there is provided an article for enriching soil fertility, the article comprising

a container comprising a fluid-permeable membrane;

a fertilizer disposed in the container; and

a moisture regulator disposed in the container,

wherein the moisture regulator is configured to repeatedly absorb moisture from outside the container and release the absorbed moisture into a space within the container based on a moisture gradient existing between the space within the container and outside the container, to control a release of the fertilizer from the container through the membrane, and

wherein the moisture regulator is further configured to form a base in the space within the container to harbor moisture-sensitive microbes, the microbes being transferable through the membrane based on the moisture gradient.

The moisture regulator may comprise a plurality of hydrogels.

The plurality of hydrogels may comprise hydrogels selected from a group consisting of homopolymeric hydrogels, copolymeric hydrogels and multipolymer interpenetrating polymeric hydrogels.

The moisture regulator may be made of a biodegradable material.

The moisture regulator may have a weight in a range of 0.1-20% of a weight of the container.

The permeable membrane may be made of a biodegradable material.

The permeable membrane may comprise at least one selected from a group consisting of kraft paper, recycled paper, sack kraft, polylactic acid derived polymers, polyhydroxyalkanoate derived polymers, polyethylene derived polymers, polyurethane derived polymers, polymer laminated onto paper and polymer laminated on polymer.

The fertilizer may comprise at least one type of fertilizer selected from a group consisting of a bio-fertilizer, a mineral fertilizer, an organic fertilizer and an inorganic fertilizer.

The bio-fertilizer may comprise the microbes disposed within at least one enclosure, the at least one enclosure comprising an external coating, and wherein the external coating is configured to dissolve after contacting moisture for a predetermined period of time, thereby providing a delayed release of the microbes.

The microbes may be selected from a group consisting of rhizobia, azotobacters, azospirillum, phosphate solubilizing bacteria (PSB), vesicular arbuscular mycorrhiza (VAM) and plant growth-promoting rhizobacteria (PGPR) selected from the genera of Pseudomonas, Enterobacter, Bacillus, Variovorax, Klebsiella, Burkholderia, Azospirillum, Serratia, Azotobacter.

The mineral fertilizer may comprise at least one selected from a group consisting of urea, ammonium chloride, ammonium sulfate, ammonium nitrate, monoammonium phosphate, diammonium phosphate, potassium chloride, potassium phosphate, borate pentahydrate, copper (II) sulphate, magnesium sulphate, ferrous sulphate, zinc sulphate, manganese sulphate, sodium molybdate.

According to a second aspect of the present invention, there is provided a method of manufacturing an article for enriching soil fertility, the method comprising the steps of:

disposing a fertilizer in a container, the container comprising a fluid-permeable membrane; and

disposing a moisture regulator in the container,

wherein the moisture regulator is capable of repeatedly absorbing moisture from outside the container and releasing the absorbed moisture into a space within the container based on a moisture gradient existing between the space within the container and outside the container, to control a release of the fertilizer from the container through the membrane, and

wherein the moisture regulator is further capable of forming a base in the space within the container to harbor moisture-sensitive microbes, the microbes being transferable through the membrane based on the moisture gradient.

According to a third aspect of the present invention, there is provided a method of enriching soil fertility, the method comprising the step of placing the article as defined in the first aspect adjacent to a root of a plant.

### BRIEF DESCRIPTION OF THE DRAWINGS

Embodiments of the invention are provided by way of example only, and will be better understood and readily apparent to one of ordinary skill in the art from the following written description and the drawings, in which:

FIG. 1 illustrates a schematic diagram of an article for enriching soil fertility in accordance with an example embodiment.

FIG. 2A illustrates the process of moisture absorption of the article of FIG. 1.

FIG. 2B illustrates the process of moisture retention in the article as shown in FIG. 2A.

FIG. 2C illustrates the process of moisture release from the article as shown in FIG. 2B.

FIG. 2D illustrates the process of activation of microbes in the article as shown in FIG. 2C.

FIG. 3 shows a flow chart illustrating a method of manufacturing an article for enriching soil fertility in accordance with an example embodiment.

### DETAILED DESCRIPTION

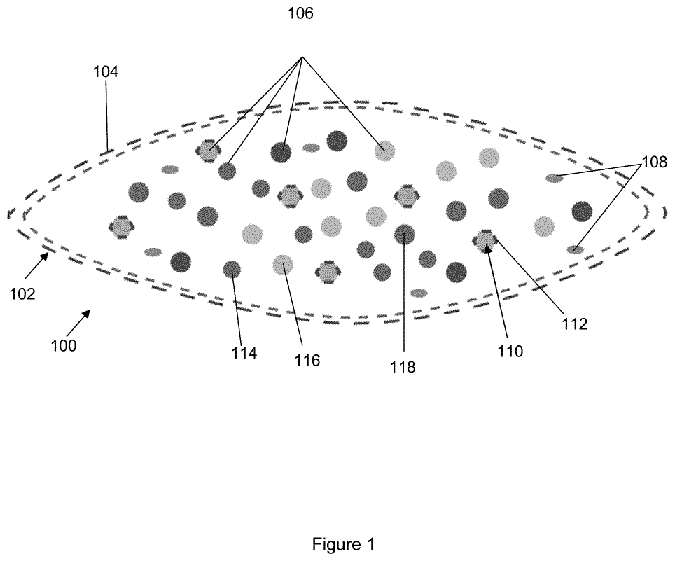

FIG. 1 illustrates a schematic diagram of an article 100 for enriching soil fertility in accordance with an example embodiment. The article 100 includes a container 102 that is made of a fluid-permeable membrane 104. The article 100 further includes multiple types of fertilizers 106 disposed in the container 102. The article 100 also includes a moisture regulator, represented as hydrogels 108 in FIG. 1, disposed in the container 102. The moisture regulator is configured to repeatedly absorb moisture from outside the container 102 and release the absorbed moisture into a space within the container 102 based on a moisture gradient existing between the space within the container 102 and outside the container 102, to control a release of the fertilizer from the container through the membrane. The moisture regulator is further configured to form a base in the space within the container 102 to harbor moisture-sensitive microbes, the microbes being transferable through the membrane based on the moisture gradient.

Examples of the hydrogels 108 include homopolymeric hydrogels, copolymeric hydrogels and multipolymer interpenetrating polymeric hydrogels. By having the ability to repeatedly absorb, retain and release moisture, the hydrogels 108 can advantageously regulate the moisture content of the soil (not shown) at a surrounding area.

For example, a surrounding environment has a high moisture concentration after a rain and that causes the hydrogels 108 to absorb the moisture. The moisture regulator typically has a weight in a range of 0.1-20% of a weight of the container. The moisture is retained in the hydrogels until the moisture concentration at the surrounding environment drops below the moisture concentration inside the article 100. Advantageously, this moisture retention in the container 102 allows migration of the microbes into the container 102 to fill in voids created from the dissolve of the fertilizers 106. The migration of the microbes into the container 102 forms a colonization of the microbes in the container 102.

When the soil becomes dry and the moisture level at the surrounding environment drops below the moisture concentration inside the container 102, the hydrogels 108 release the absorbed moisture back to the soil. The moisture released from the hydrogel 108 dissolves the fertilizers and the nutrients from the fertilizers would be absorbed by the plants.

The fertilizers 106 include a type of bio-fertilizer 110 which includes microbes that support plant growth. The microbes are typically selected from the plant-associated microbial community, plant growth promoting microbes (PGPM) and root-associated microbial community. Examples of microbes include rhizobia, azotobacters, azospirillum, phosphate solubilizing bacteria (PSB), vesicular arbuscular mycorrhiza (VAM) and plant growth-promoting rhizobacteria (PGPR) selected from the genera of Pseudomonas, Enterobacter, Bacillus, Variovorax, Klebsiella, Burkholderia, Azospirillum, Serratia, Azotobacter.

In an embodiment, the microbes are disposed within an enclosure that includes an external coating 112. The external coating 112 can provide protection to the microbes and will dissolve completely after contacting moisture for a predetermined period of time, thereby providing a delayed release of the microbes. The activated microbes generally migrate according to the flow direction of the moisture. Thus, when the hydrogels 108 release moisture, the microbes migrate outwards to the soil. Microbial activities in soils are found to promote release of nutrients from minerals and organic matters in the soil for use by plants.

In an embodiment, the fertilizers 106 further include mineral fertilizer 114, an organic fertilizer 116 and inorganic fertilizers 118. These fertilizers are hygroscopic fertilizers that are capable of absorbing moisture from the air. In contact with moisture, these fertilizers dissolve to supply nutrients to the plants. When the soil is dry, the moisture released from the hydrogel 108 dissolves the fertilizers and the nutrients from the fertilizers would be absorbed by the plants. Thus, the use of the article 100 may advantageously ensure that the plants are supplied with water and nutrients even when the soil is dry.

Examples of mineral fertilizers 114 include urea, ammonium chloride, ammonium sulfate, ammonium nitrate, monoammonium phosphate, diammonium phosphate, potassium chloride, potassium phosphate, borate pentahydrate, copper (II) sulphate, magnesium sulphate, ferrous sulphate, zinc sulphate, manganese sulphate, sodium molybdate, etc.

Examples of organic fertilizers 116 include compost, rock phosphate, etc.

The supply of nutrients and microbes from the fertilizers 106 to the crops can be enhanced using this article 100 due to constant moisture supply, whether from the surrounding environment or from the hydrogel 108. In other words, even when the surrounding environment is dry, the hydrogels 108 can provide the necessary moisture to dissolve the fertilizers 106. This timely supply of nutrients and microbes to the crops can ensure crop and soil productivity.

It will be appreciated that the external coating 112 may be excluded from the bio-fertilizers 110 such that the release of the microbes would not be delayed. Further, in addition to the bio-fertilizers 110, other types of fertilizers contained in the container 102 may also selectively include an external coating if there is a need to delay the release of some specific nutrients.

The container 102 is a porous, flexible and sealed bag formed by the permeable membrane 104. As shown in FIG. 1, the container 102 is in an oval shape. The shape of the container 102 may vary depending on the moisture and quantity of substances in the container 102.

The material of the permeable membrane 104 includes but is not limited to the following: kraft paper, recycled paper, sack kraft, polylactic acid derived polymers, polyhydroxyalkanoate derived polymers, polyethylene derived polymers, polyurethane derived polymers, polymer laminated onto paper, polymer laminated on polymer, etc.

It will be appreciated that the container 102 may not be completely sealed. Instead, the container 102 can be an open-ended container with a closure means, such as a flap. This may advantageously allow refilling of substances into the container 102 at a suitable time. Further, it will be appreciated that, depending on the need of the crops, the container 102 may further contain substances such as enzymes and yield enhancers.

In use, the article 100 is placed adjacent to a root of a plant, such as on the soil, or partially or completely buried in the soil. In an embodiment, the container 102 and the moisture regulator are made of biodegradable materials. Thus, the article 100 will decompose in the environment after a period of time. This is advantageous to the environment as the use of the article 100 would not cause any pollution. Also, this can result in significant economic and time savings since it is not necessary to dispose the article 100 after use.

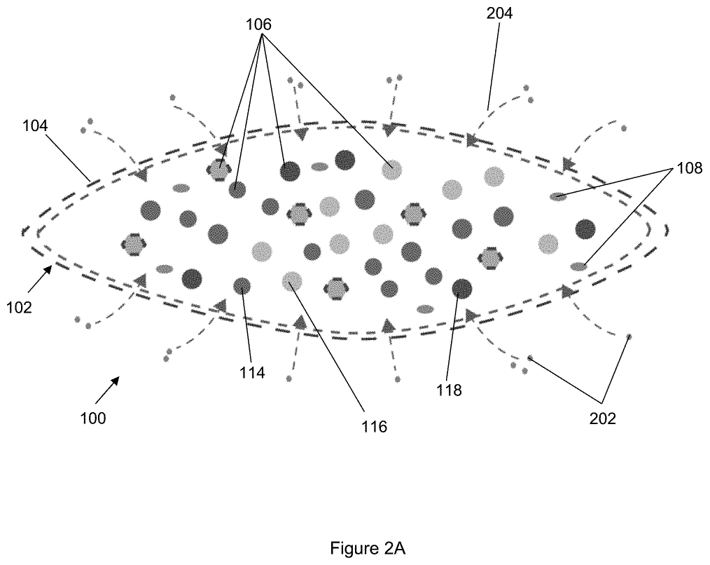

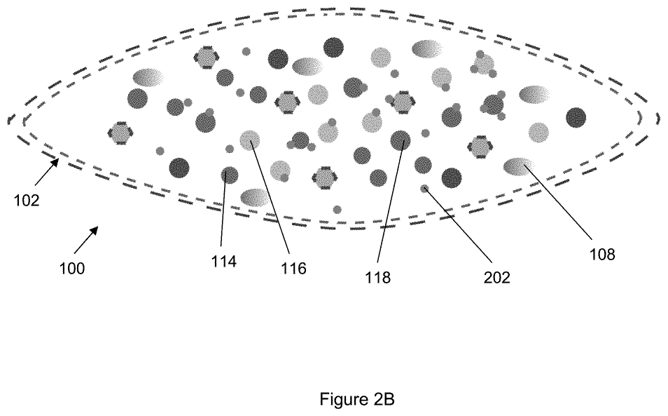

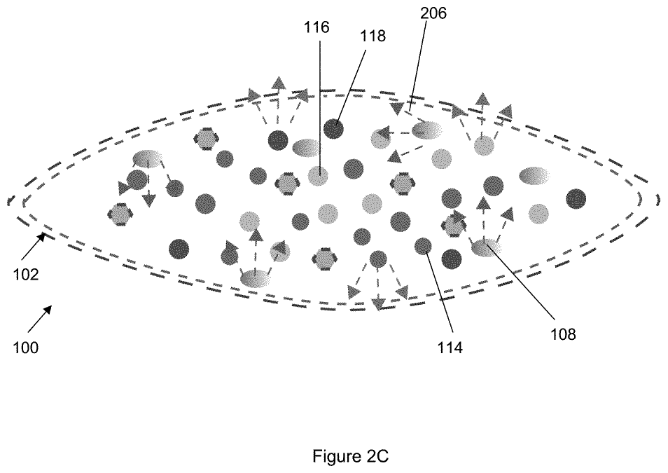

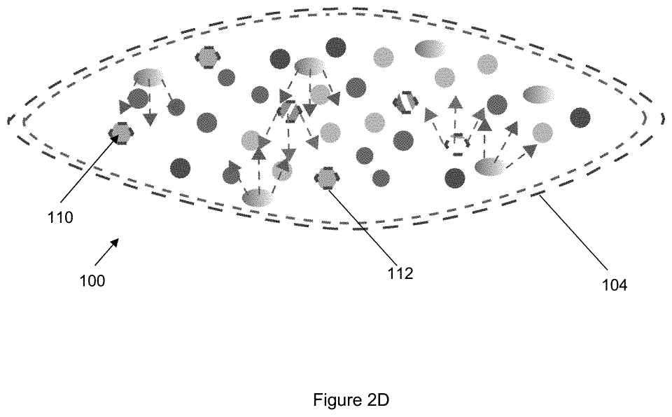

FIG. 2A illustrates the process of moisture absorption of the article 100 of FIG. 1. Here, the article 100 is placed at a surrounding environment with high moisture concentration. Moisture 202 penetrates into the container 102 via the permeable membrane 104 following a concentration gradient of the moisture molecules across the permeable membrane 104, as shown with arrows 204 in FIG. 2A.

The mineral fertilizer 114, organic fertilizer 116 and inorganic fertilizers 118 dissolve in contact with the moisture 202 and the solution of these fertilizers in the moisture 202 is released into the surrounding environment gradually following a concentration gradient of the fertilizers molecules across the permeable membrane 104. At the same time, the hydrogels 108 absorb the moisture 202 and expand in size.

FIG. 2B illustrates the process of moisture retention in the article 100 as shown in FIG. 2A. Here, the moisture concentrations are in equilibrium at the inside and outside of the article 100. The moisture 202 is retained in the hydrogels 108, while the mineral fertilizer 114, organic fertilizer 116 and inorganic fertilizers 118 continue to dissolve in the moisture 202 and continue to be released to the surrounding environment depending on a concentration gradient of the fertilizers molecules across the permeable membrane 104.

FIG. 2C illustrates the process of moisture release from the article 100 as shown in FIG. 2B. Here, the moisture concentration at the surrounding environment drops below the moisture concentration inside the article 100. The moisture 202 is released by the hydrogels 108 into the space within the container 102, as shown with arrows 206 in FIG. 2C. The released moisture 202 also dissolves the mineral fertilizer 114, organic fertilizer 116 and inorganic fertilizers 118.

FIG. 2D illustrates the process of activation of microbes in the article 100 as shown in FIG. 2C. Here, the external coating 112 of bio-fertilizer 110 dissolves following a contact with moisture 202 for a period of time and as a result, the microbes enclosed within the external coating 112 are released. The rate of activation of the microbes depends on the moisture level of the article 100. The released microbes then migrate across the permeable membrane 104 by way of the flow of moisture into the soil.

When the moisture concentration at the surrounding environment increases to a level higher than that of the article 100, the processes explained above with respect to FIGS. 2A to 2D is repeated. Some or all the fertilizers 106 would have been dissolved at the start of the new cycle, leaving some voids within the article 100. The microbes from the surrounding environment would migrate into the article 100 to fill in the voids, following the flow of moisture 202 into the article 100.

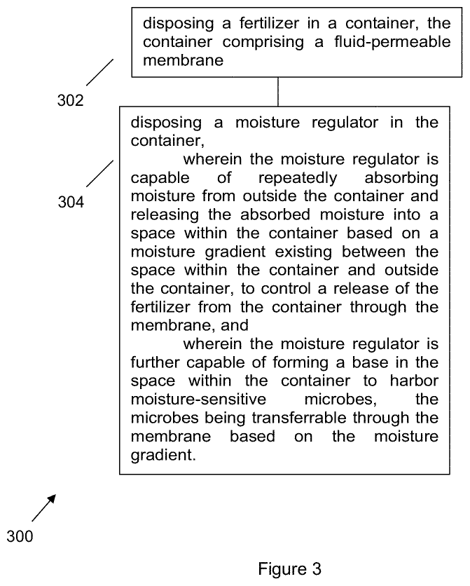

FIG. 3 shows a flow chart 300 illustrating a method of manufacturing an article for enriching soil fertility in accordance with an example embodiment. At step 302, a fertilizer is disposed in a permeable membrane. At step 304, a moisture regulator is disposed in the permeable membrane. The moisture regulator is configured to repeatedly absorb, retain and release moisture. The moisture regulator is capable of repeatedly absorbing moisture from outside the container and releasing the absorbed moisture into a space within the container based on a moisture gradient existing between the space within the container and outside the container, to control a release of the fertilizer from the container through the membrane. The moisture regulator is further capable of forming a base in the space within the container to harbor moisture-sensitive microbes, the microbes being transferable through the membrane based on the moisture gradient.

Embodiments of the present invention provide an article 100 for enriching soil fertility and a method of manufacturing the same. The article 100 includes a container 102 containing fertilizers 106 and hydrogels 108. When the moisture concentration at the soil is high, the hydrogels 108 absorbs and retains moisture in a space within the container 102. This may advantageously allow migration of microbes into the container 102 to form a colonization of the microbes within the container. When the moisture concentration at the soil is low, the hydrogels 108 can release absorbed moisture to dissolve the fertilizers 106 to provide the necessary moisture, nutrients and microbes to the crops.

The simple container design provides an easy and effective manuring and treatment process. The quantity of the fertilizers 106 can be measured and contained in the container 102 which does not get washed away easily with the flow of water. Using the article 100, the rate of the nutrients and microbes release can be controlled due to the constant supply of moisture 202. Thus, the nutrients and microbes supply to the crops can be administered easily.

Adequate moisture, nutrients and microbes in the soil can enhance the growth of the crops and the ability of the crops to tolerate abiotic and biotic stresses such as drought, salinity, and heavy metal toxicity.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. An article for enriching soil fertility, the article comprising:
a container comprising a fluid-permeable membrane;
a fertilizer disposed in the container; and
a moisture regulator disposed in the container,
wherein the moisture regulator is configured to repeatedly absorb moisture from outside the container and release the absorbed moisture into a space within the container based on a moisture gradient existing between the space within the container and outside the container, to control a release of the fertilizer from the container through the membrane, and
wherein the moisture regulator is further configured to form a base in the space within the container to harbor moisture-sensitive microbes, the microbes being transferable through the membrane based on the moisture gradient.

2. The article as claimed in claim 1, wherein the moisture regulator comprises a plurality of hydrogels.

3. The article as claimed in claim 2, wherein the plurality of hydrogels comprise hydrogels selected from a group consisting of homopolymeric hydrogels, copolymeric hydrogels and multipolymer interpenetrating polymeric hydrogels.

4. The article as claimed in claim 1, wherein the moisture regulator is made of a biodegradable material.

5. The article as claimed in claim 1, wherein the moisture regulator has a weight in a range of 0.1-20% of a weight of the container.

6. The article as claimed in claim 1, wherein the permeable membrane is made of a biodegradable material.

7. The article as claimed in claim 1, wherein the permeable membrane comprises at least one selected from a group consisting of kraft paper, recycled paper, sack kraft, polylactic acid derived polymers, polyhydroxyalkanoate derived polymers, polyethylene derived polymers, polyurethane derived polymers, polymer laminated onto paper and polymer laminated on polymer.

8. The article as claimed in claim 1, wherein the fertilizer comprises at least one type of fertilizer selected from a group consisting of a bio-fertilizer, a mineral fertilizer, an organic fertilizer and an inorganic fertilizer.

9. The article as claimed in claim 8, wherein the bio-fertilizer comprises the microbes disposed within at least one enclosure, the at least one enclosure comprising an external coating, and wherein the external coating is configured to dissolve after contacting moisture for a predetermined period of time, thereby providing a delayed release of the microbes.

10. The article as claimed in claim 9, wherein the microbes are selected from a group consisting of rhizobia, azotobacters, azospirillum, phosphate solubilizing bacteria (PSB), vesicular arbuscular mycorrhiza (VAM) and plant growth-promoting rhizobacteria (PGPR) selected from the genera of Pseudomonas, Enterobacter, Bacillus, Variovorax, Klebsiella, Burkholderia, Azospirillum, Serratia, Azotobacter.

11. The article as claimed in claim 8, wherein the mineral fertilizer comprises at least one selected from a group consisting of urea, ammonium chloride, ammonium sulfate, ammonium nitrate, monoammonium phosphate, diammonium phosphate, potassium chloride, potassium phosphate, borate pentahydrate, copper (II) sulphate, magnesium sulphate, ferrous sulphate, zinc sulphate, manganese sulphate, sodium molybdate.

12. A method of manufacturing an article for enriching soil fertility, the method comprising the steps of:
disposing a fertilizer in a container, the container comprising a fluid-permeable membrane; and
disposing a moisture regulator in the container,
wherein the moisture regulator is capable of repeatedly absorbing moisture from outside the container and releasing the absorbed moisture into a space within the container based on a moisture gradient existing between the space within the container and outside the container, to control a release of the fertilizer from the container through the membrane, and
wherein the moisture regulator is further capable of forming a base in the space within the container to harbor moisture-sensitive microbes, the microbes being transferable through the membrane based on the moisture gradient.

13. A method of enriching soil fertility, the method comprising the step of placing the article as claimed in claim 1 adjacent to a root of a plant.
